(19) United States
(12) Patent Application Publication
(10) Pub. No.: US 2016/0044146 A1
(43) Pub. Date: Feb. 11, 2016

(54) Solar Integrated Mobile and Electronic Devices with Backside Solar Panels

(71) Applicant: Princess Danielle Mitchell, Simpsonville, SC (US)

(72) Inventor: Princess Danielle Mitchell, Simpsonville, SC (US)

(21) Appl. No.: 14/789,432

(22) Filed: Jul. 1, 2015

Related U.S. Application Data
(60) Provisional application No. 62/024,468, filed on Jul. 15, 2014.

(51) Int. Cl. H04M 1/02; H04W 52/02

(52) U.S. Cl. CPC H04M 1/0202; H04W 52/0261

(57) ABSTRACT

Introducing a solar energy based technology that introduces mobile and electronic devices to energy and power by way solar integration. Solar panels will be positioned on the backside of the device's outer shell where it will also be embedded within the outer casing. The solar energy to the mobile terminal's power management system will function in one or more of the following modes: 1) allow usage of mobile devices (also known as “cellular” devices) with battery as a back-up energy source; 2) provide the ability to recharge a low or dead battery by way of the trickle charge effect when device is not in use; and/or 3) the use of a switch-mode-power-supply (SMPS) which will allow mobile device to be manually switched between energy usage using either solar/light power or a battery.

There are copious additional advantages and features of this invention that will become readily apparent from the following detailed description of the invention and the embodiments thereof, from the claims, and from the accompanying drawings.

Applicant claims the benefit of Provisional Patent Application Of Application No. 62/024,468

### BACKGROUND OF THE INVENTION

Existing mobile and electronic devices require a battery and electrical charging in order to recharge existing battery. Once the battery is exhausted, the mobile device is then rendered useless without an electrical power source and charging cable.

There has been attempts and creative ideas for creating mobile and/or electronic devices that provides the alternative solar charging and powering, however those attempts and creative ideas have various shortcomings that has thwarted the effectiveness, usefulness and, sequentially, its creations.

Through my research, I have learned that there are several existing art that has a somewhat similar feature or capability. For example: U.S. Pat. No. 7,295,865 is entitled Mobile Device with Cell Array. The '865 patent covers a mobile device having built-in cell arrays that convert sunlight and such into electricity to power the mobile device. These built-in cell arrays are located at the front of the mobile device.

U.S. Pat. No. 6,847,834 is entitled Mobile Terminal With A Solar Cell. The '834 patent covers a mobile device with a flip cover that has solar cells attached to the outer surface of that flip cover. The '834 patent also includes a voltage booster such that the voltage of the solar cells are boosted prior to being sent to the battery(ies) and the mobile device. The power management circuitry disclosed by the '834 patent covers a mobile device that uses the rechargeable batteries as its primary power. Only when the batteries are fully charged or when the solar cells voltage is greater than the batteries will the mobile device use the solar cells to power the device.

U.S. Pat. No. 6,997,479 is entitled Portable Cell Phone Battery Charger Using Solar Energy As The Primary Source of Power. The '479 patent covers a gadget that is external to the mobile device. The gadget has solar panels and batteries contained therein such that the gadget may recharge or power the mobile device either with the solar arrays or by the batteries contained in the gadget.

U.S. Pat. No. 5,898,932—entitled Portable Cellular Phone With Integral Panel—includes a cellular phone having a rear face covered with solar panels. The solar panels are used to recharge the batteries in the cell phone.

U.S. Patent Application Publication 2005/0282591—entitled Solar-Powered Mobile Telephone—discloses supplementing battery power with solar power.

There is a great need for improvements in the industry of powering mobile and/or electronic devices of all types, sizes and functionalities. And this present invention, through its embodiments, now known or hereafter developed, provides for alternatives and improvements over each and/or combined, prior art.

### SUMMARY OF THE INVENTION

The object of this invention is to provide an improved solar powered and operated alternative when mobile and electronic devices get low, or loses, its battery life.

This present invention includes mobile and electronic devices with solar panels, or solar cell arrays, mounted on the backside of the device's outer backings, covering, exterior, or shell whereby the solar panel is exposed to light thereby powering the device or trickle charging its power and/or operating batteries. These solar panels are mounted into a horizontal position to expose it to light without the possibility of being fully covered by the device user (particularly a cellular device user) when using the device.

The solar panels will not take away from, or interfere, with today's existing mobile and/or electronic devices that may be thinner, smaller and much more technologically functional than past devices.

Additionally, another objective for this invention is to provide the portable and electronic devices having a battery supply which is trickle charged by a solar cell array.

By way of this present invention, its objectives may further allows for the mobile and/or electronic devices to have a nearly never-ending power live span or source. This permits the device to have nearly uninterrupted talk time; nearly uninterrupted text messaging application capability; nearly uninterrupted safety/emergency access; nearly uninterrupted internet usage; nearly uninterrupted email application; nearly unlimited standby and overall usage time capabilities.

Whether the mobile and/or electronic device has the capability of, or is using, either mode functionality of complete solar energy, rechargeable battery, and/or manually switching the device between battery and the solar cell array, the device now—with this present invention—has the opportunity to remain functional and its contents accessible. With this there are no limited chances for the mobile and/or electronic devices to be rendered useless and lack emergency safety access and operation.

The solar panels used to power the devices power management system will be small, flat panels similar to those located on a solar powered calculator. The solar, or photovoltaic, panels will have the ability of converting sunlight, ambient lights, and starlight into electricity in order to power the mobile and/or electronic devices.

This present invention allows for mobile and/or electronic devices to use an alternative energy source integration to power its operation so the device may be used anytime and anywhere without the immediate need for an external power outlet or source.

The mobile and/or electronic devices that can benefit from and use this present invention including the removable covers and backings include mobile/cellular phones, remote controlled devices (DVDs, TVs, camcorders, projectors, etc.), cordless phones, instruments (clocks, cameras, etc.), electronics (laptops, iPads, tablets, etc.), gaming consoles (Xbox, Playstation, etc.), amongst other similar electronic and/or mobile devices.

The device's power management system may also have a rechargeable battery. With the SMPS functionality, the device can be manually switched to “green” for operating on solar energy alone; “red” for operating solely on a battery power; and/or “black” for battery recharge via solar power. This existing rechargeable battery may also be attached to an external charging cable, outlet and/or port in order to recharge the battery. The battery being charged by the external charger will not impact and/or be impacted by the device being in either the “green,” “red,” or “black” positions.

In the aforementioned scenarios: the ability to set/alternate switches may include the ability to turn the switches on/off and/or to an intermediate position so that the power flows in the proper directions with avoidance of electrical switching noise, harmonic distortions, electromagnetic interference (EMI), or ripple voltage that can occur at the switching frequencies.

Additionally, the invention's dependent claims include:
1) The preferred embodiment of the mobile and/or electronic device solar panels is within/on/about the device's backside and/or around/about the side(s) of its original case/shell due to the casing material for the panels being readily available.
2) Of claim 1 description of the terms “cover” and “backings” outlined in claim 4, I anticipated and further claim that other materials are available that would be suitable for an alternative embodiment of housing of the solar panels for use of charging and/or recharging the mobile and/or electronic devices; such as the complete/partial mold and/or complete/partial removable cover, case or backing constructed from rubber, plastic, metal, silicone, acrylic, plexiglass, and/or other similar material, wherein the solar panels are located on the backside and/or around/on either one, multiple or all side(s) of the cover or backings.
3) The cover, backing or mold can be in one whole design or piece or it can come in the form of two separate, and/or multiple other parts/pieces that snugly fit/snap/clap/clasp together as a whole.
4) Those in the art will understand that cover, backing or any suitable material, as well as the location/position of the solar panels, now known or hereafter developed or created, may be used in forming and/or creating a mobile and/or electronic device, or cover/backing, with solar power capability.

### A BRIEF DESCRIPTION OF THE DRAWINGS

FIG. 1: 1A & 1B are perspective views of the front and back (or rear) sides of a mobile cellular device (particularly the iPhone for exemplary and illustrative purposes only) embodying the present invention wherein the backside of the device shows the solar cell arrays exposed to the light;

FIG. 2: 2A & 2B are perspective views of the front and back sides of a mobile cellular device (particularly the Android device for exemplary and illustrative purposes only) embodying the present invention wherein the backside of the device shows the solar cell arrays exposed to the light;

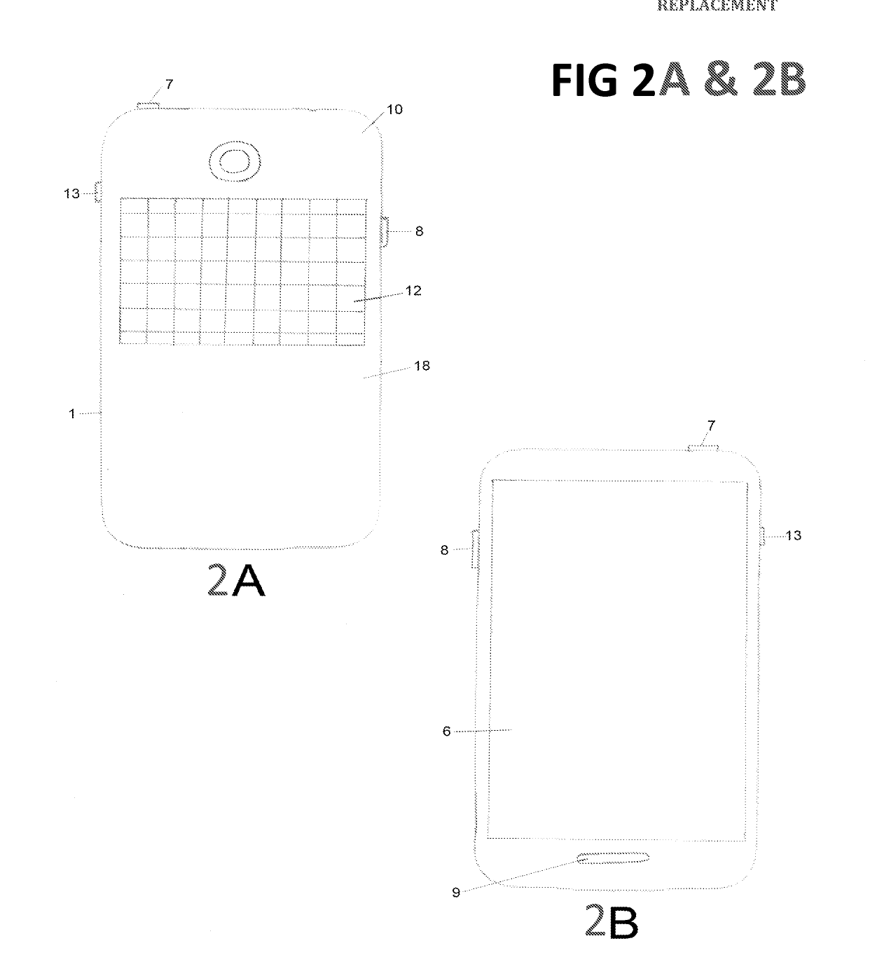

FIG. 3: 3A & 3B shows perspective views of the front and back (or rear) sides of a removable and separating housing or cover structure/device that will completely enclose and/or cover the entire back and sides of a mobile or electronic device wherein the solar panels are located on the backside of larger bottom piece, as well as all four sides (for optional panel location and position example only).

FIG. 4: 4A, 4B, 4C & 4D shows perspective views of the top (4A) and bottom (4B), and left side (4C) and right side (4D), of a removable and separating housing or cover structure/device that will completely enclose and/or cover the entire back and sides of a mobile or electronic device wherein the solar panels are located on the backside of larger bottom piece, as well as all four sides (for optional panel location and position example only).

### DETAILED DESCRIPTION OF THE INVENTION

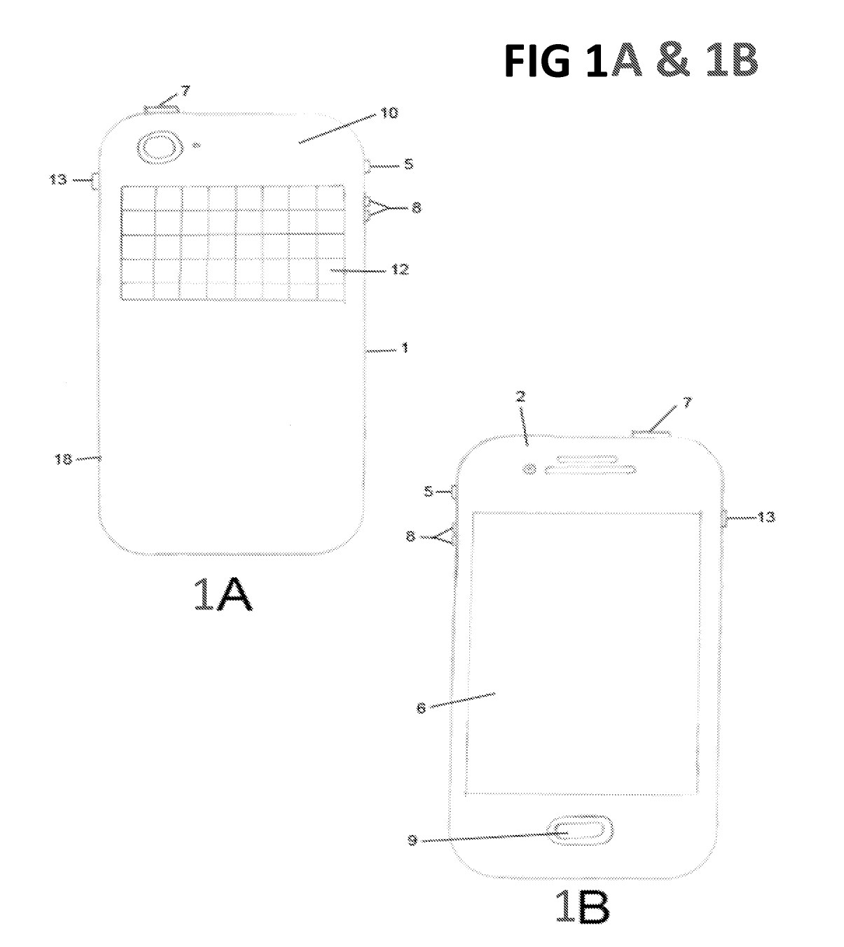

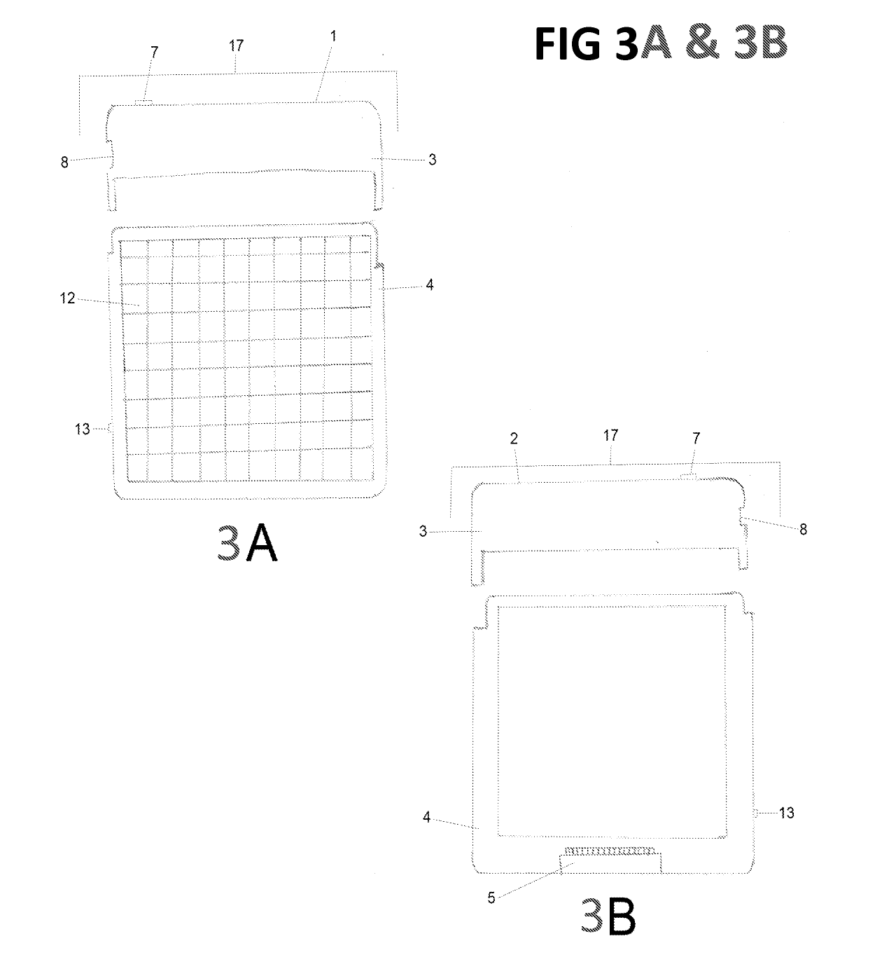

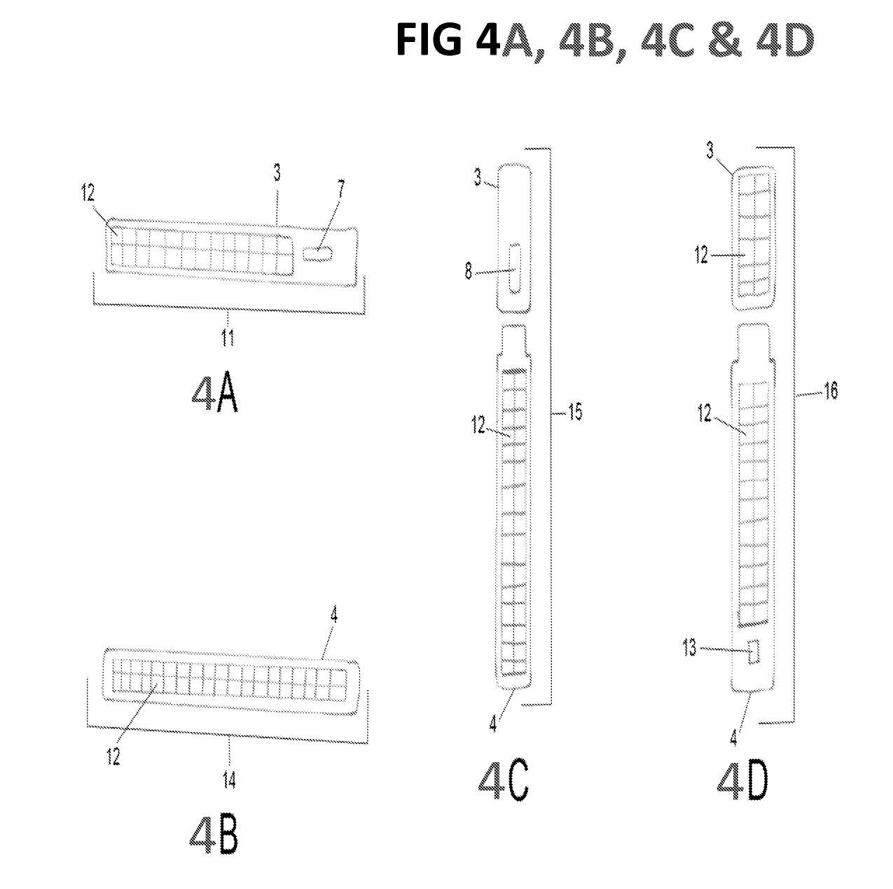

Referring to FIGS. 1A & 1B and 2A & 2B (using the models of an iPhone and Android for description and exemplary purposes only) wherein the preferred embodiments are illustrated: the mobile device 18, a manual ringer on/off switch 5 (available on some devices), touchscreen display 6, power button 7, volume controls 8, a home button 9, manual solar usage on/off switch (available on select devices) 13 that provides the option of “green” for solar usage, “red” battery usage, and “black” for charge/recharge battery using solar/sun/light capability, all contained in/on the device 18. The rear/back side 1 of the device 18 includes the exterior cover/shell 10 and the horizontal solar cell panel(s) 12 (which can cover the backside partially or fully) mounted within the housing unit of the device which is powered and/or trickle charged by the solar cell array 12. The front side 2 of the device includes the touchscreen display 6 and the home button 9. FIG. 3A & 3B and FIG. 4A, 4B, 4C & 4D shows the perspectives of multiple positions (FIG. 3A back 1, FIG. 3B front 2, FIG. 4A top 11, FIG. 4B bottom 14, FIG. 4C left side 15, FIG. 4D right side 16) of a separating, removable housing/cover 17. Whereas the backside 1 shows a top cover piece 3 that will snuggly fit into/with the bottom cover piece 4 when the two are pressed together—closing the removable housing/cover structure/device around the mobile or electronic device. The front view 2 illustrates a charging port 5 that will insert into the mobile or electronic device and will allow for the solar powering capability of/from the solar panels 12 to charge/recharge/power the mobile or electronic device 18. All of the solar panels 12 located about/on the back of the mobile/electronic device 18 and/or removable case/mold/backing/housing 17 can come to fully or partially cover the entire backside of the device 18, 17 and/or on one or multiple sides 11, 14, 15, 16.

1. Mobile and electronic devices becoming energized and powered by way of solar integration, adapters and housings (covers, backings, etc.).

2. Solar panels will be positioned partially/fully on the backside of the device's outer casing (or exterior case) where it will also be embedded within the outer casing. The solar energy to the mobile terminal's power management system will function in one or more of the following modes: 1) allow usage of mobile devices (also known as “cellular” devices) with battery as a back-up energy source; 2) provide the ability to recharge a low or dead battery by way of the trickle charge effect when device is not in use; and/or 3) the use of a switch-mode-power-supply (SMPS) which will allow mobile device to be manually switched between energy usage using either solar/light power and/or a battery.

3. When in standby mode, or not in use, the power source management system of the mobile and electronic devices automatically recharges the battery by way of solar or light power trickle charge effect.

4. The mobile and electronic devices becoming energized and powered by way of solar integration, adapters and housings (covers, backings, etc.) of claim 1, wherein the terms “housing,” “covers” and “backings” is used in a functional sense indicating a removable, replaceable and/or separating structural member of/for the mobile and electronic devices such as a housing, mold, case, cover, and/or backing separate from the actual/original mobile or electronic device. Examples include the embodiment of a whole/partial housing, mold, case, cover, backing or casing that completely or partially enclose or cover the mobile or electronic device, and can be added on or taken off as needed. This “cover” and “backings” embodiment is constructed from rubber, plastic, metal, silicone, acrylic, plexiglass, and/or other similar material, wherein the solar panels can be placed located on the backside and/or around either or all of the side(s) of the cover or backings.
